(19) United States
(12) Patent Application Publication
(10) Pub. No.: US 2013/0151588 A1
(43) Pub. Date: Jun. 13, 2013

(54) VEHICLE TO DRIVER CHRONICLE SYSTEM

(71) Applicant: Intelligent Mechatronic Systems Inc., Waterloo (CA)

(72) Inventor: Otman A. Basir, Waterloo (CA)

(73) Assignee: INTELLIGENT MECHATRONIC SYSTEMS INC., Waterloo (CA)

(21) Appl. No.: 13/677,730

(22) Filed: Nov. 15, 2012

Related U.S. Application Data
(60) Provisional application No. 61/560,030, filed on Nov. 15, 2011.

(51) Int. Cl. H04L 12/58

(52) U.S. Cl. CPC H04L 51/00
USPC 709/203

(57) ABSTRACT

This vehicle monitoring and reporting system provides a platform for providing improved communication of information to the driver and/or vehicle owner (collectively “the user”). A user can create a customized report to be sent to the user. The report can indicate (among other things) driving behavior, such as average speed and maximum speed, vehicle health data and driving tips. The report can also include coupons or advertisements that are based upon location information and vehicle health data gathered from the data.

### BACKGROUND

Some telematics systems monitor vehicle and driver events and conditions. A device installed in the vehicle may include one or more on-board sensors, such as accelerometers (such as a three-axis accelerometer), a gps receiver, etc. The device may receive further information from the vehicle's on-board diagnostics port (e.g. OBD-II), including vehicle speed. This information, or summaries thereof, may be sent to a server (or multiple servers) for collection and analysis.

One way this information can be used is for determining a rate of car insurance that should be charged for the driver and/or vehicle. Some of this information is made available to the driver and/or vehicle owner, such as via a web browser (or via the internet through a dedicated application).

### SUMMARY

This vehicle monitoring and reporting system provides a platform for providing improved communication of information to the driver and/or vehicle owner (collectively “the user”). A user can create a customized report to be sent to the user. The report can indicate (among other things) driving behavior, such as average speed and maximum speed, vehicle health data and driving tips. The report can also include coupons or advertisements that are based upon location information and vehicle health data gathered from the data.

### BRIEF DESCRIPTION OF THE DRAWINGS

FIG. 1 is a schematic of a monitoring system according to one embodiment of the present invention.

FIG. 2 is a sample chronicle created by the system of FIG. 1 and sent to the user.

FIG. 3 shows one possible interface permitting the user to customize the chronicle.

### DETAILED DESCRIPTION

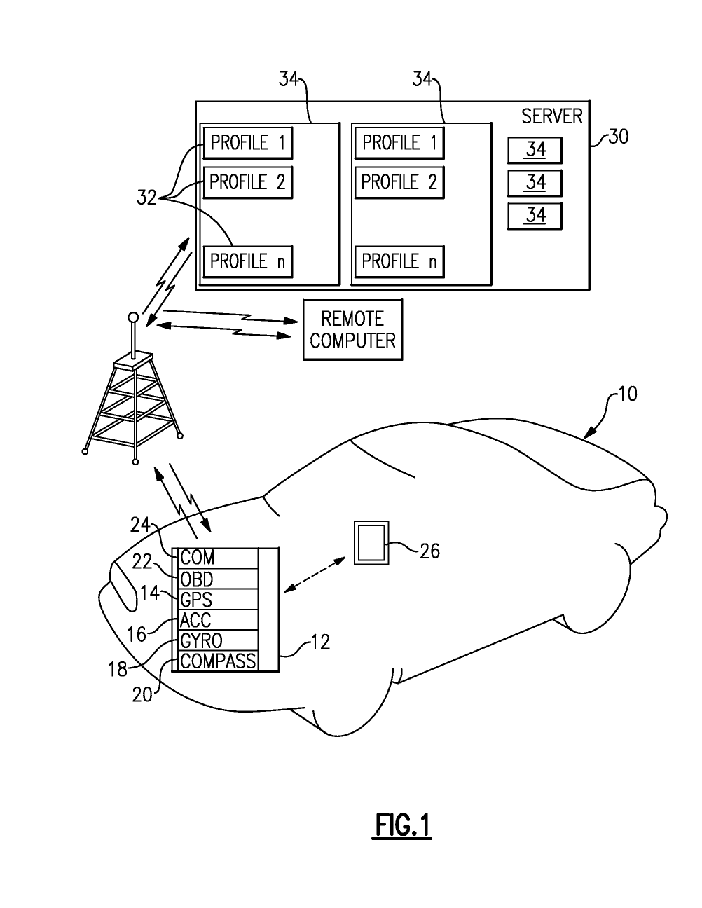

Referring to FIG. 1, a motor vehicle 10 includes a plurality of data gathering devices that communicate information to an appliance 12 installed within the vehicle 10. The example data gathering devices include a global positioning satellite (GPS) receiver 14, an accelerometer 16, a gyroscope 18 and an electronic compass 20, which could be housed within the appliance 12 (along with a processor and suitable electronic storage, etc.). As appreciated, other data monitoring systems could be utilized within the contemplation of this invention. Data may also be collected from an on-board diagnostic port (OBD) 22 that provides data indicative of vehicle engine operating parameters such as engine speed, temperature, fuel consumption (or electricity consumption), engine idle time, car diagnostics (from OBD) and other information that is related to mechanical operation of the vehicle. Moreover, any other data that is available to the vehicle could also be communicated to the appliance 12 for gathering and compilation of the operation summaries of interest in categorizing the overall operation of the vehicle. Not all of the sensors mentioned here are necessary, however, as they are only listed as examples.

The appliance 12 may also include a communication module 24 (such as cell phone, satellite, wi-fi, etc.) that provides a connection to a wide-area network (such as the internet). Alternatively, the communication module 24 may connect to a wide-area network (such as the internet) via a user's cell phone 26 or other device providing communication.

The in vehicle appliance 12 gathers data from the various sensors mounted within the vehicle 10 and stores that data. The in vehicle appliance 12 transmits this data (or summaries or analyses thereof) as a transmission signal through a wireless network to a server 30 (also having at least one processor and suitable electronic storage and suitably programmed to perform the functions described herein). The server 30 utilizes the received data to categorize vehicle operating conditions in order to determine or track vehicle use. This data can be utilized for tracking and determining various parameters such as driver behavior, insurance premiums for the motor vehicle, tracking data utilized to determine proper operation of the vehicle and other information that may provide value such as alerting a maintenance depot or service center when a specific vehicle is in need of such maintenance. Driving events and driver behavior are recorded by the server 30, such as fuel and/or electricity consumption, speed, driver behavior (acceleration, speed, etc.), distance driven and/or time spent in certain insurance-risk coded geographic areas. For example, the on-board appliance 12 may record the amount of time or distance in high-risk areas or low-risk areas, or high-risk vs. low risk roads. The on-board appliance 12 may collect and transmit to the server 30 (among other things mentioned herein): Speed, Acceleration, Distance, Fuel consumption, Engine Idle time, Car diagnostics, Location of vehicle, Engine emissions, etc.

The server 30 includes a plurality of profiles 32, each associated with a vehicle 10 (or alternatively, with a user). Among other things, the profiles 32 each contain information about the vehicle 10 (or user) including some or all of the gathered data (or summaries thereof). Some or all of the data (or summaries thereof) may be accessible to the user via a computer 32 over a wide area network (such as the internet) via a policyholder portal, such as fuel efficiency, environmental issues, location, maintenance, etc. The user can also customize some aspects of the profile 32.

It should be noted that the server 30 may be numerous physical and/or virtual servers at multiple locations. The server 30 may collect data from appliances 12 from many different vehicles 10 associated with a plurality of insurance companies. Each insurance company (or other administrator) may configure parameters only for their own users. The server 30 permits the administrator of each insurance company to access only data for their policyholders. The server 30 permits each policyholder to access only his own profile and receive information based upon only his own profile.

The server 30 may not only reside in traditional physical or virtual servers, but may also coexist with the on-board appliance, or may reside within a mobile device. In scenarios where the server 30 is distributed, all or a subset of relevant information may be synchronized between trusted nodes for the purposes of aggregate statistics, trends, and geo-spatial references (proximity to key locations, groups of drivers with similar driving routes).

The portal for the user to interact with the server 30 to view reports and configure their periodicity and structure. A report is automatically generated and transmitted to the recipient (car driver, car owner, fleet manager) periodically (daily, weekly, monthly, yearly). The report will automatically be transmitted to the user as an attachment to an email, email, or sms. Traditional (paper) mail delivery options are also available where appropriate. The report will indicate one or more of the following pieces of information:

Min, max, Average speed for the reported period.

Driving behavior indicators: aggressive, responsible, rough, etc.

Total idle time for the period.

Total driving time including idle time for the period.

Total distance driven for the period.

Total emission for the period, optionally with a comparison to average emission and allowable or typical emissions in the region, for similar vehicles, for similar user criteria, and/or for commuters who tend to commute in similar area.

Vehicle health report and explicit advices on actions to be taken by the recipient: for example, battery diagnostic to indicate prediction of battery failure. The recipient will be informed to make sure to take the vehicle to a mechanic to check battery condition. Same on other types of vehicle components such as air quality sensors, oil quality, filters, lights, etc.

The report may include visual arts to simplify the presentation of information to the recipient using pie charts, bar charts, lines, (healthy trees, damaged trees, in case of emissions).

The report may indicate alternative routing to frequently travelled routes to reduce distance traveled, fuel consumed, idle time, and/or driving time.

Based on the diagnostic report on the car health, an advertisement space may be created in the report to refer the recipient to a specialist (vehicle repair chain, dealership, etc.). This space may include a coupon for a discount the recipient will receive if he shows the coupon to the recommended specialist. The specialist may be determined on best value to the recipient, taking in consideration closeness to recipient geographical location and commute paths.

The recipient can configure the frequency of the report by sending a message to the reporting system (i.e. sending a reply using the same delivery method in which the report was received), or by logging into the system's portal.

The recipient can optionally configure the report to also be delivered to a relevant recipient on specific trigger conditions. This optional conditional delivery of the chronicle can be used to share information with relevant parties, or to automatically inform a specialist when certain vehicle health triggers are identified.

The report is structured as a chronicle, allowing for co-branding with partners and banners to promote safe and green driving.

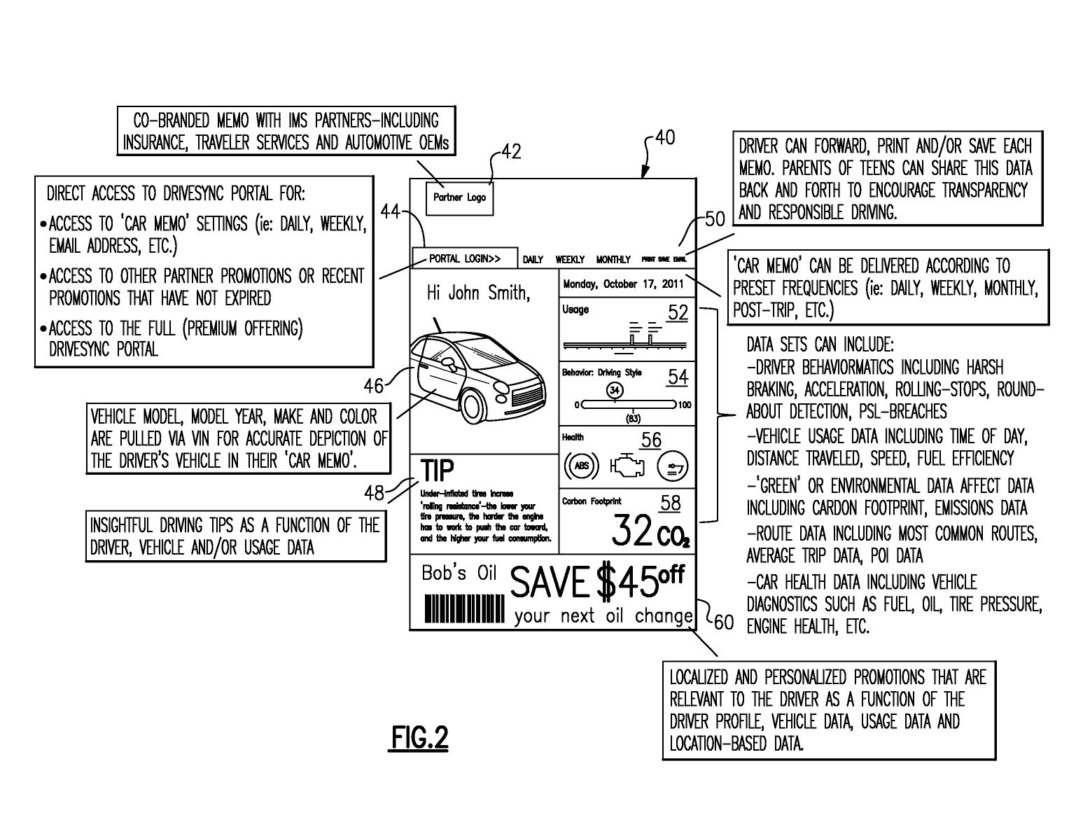

An example chronicle 40 is shown in FIG. 2. The chronicle 40 could be a pdf or other document or a formatted email or a webpage linked from an email. Other delivery options could also be used. The chronicle 40 may include a co-branding logo area 42, a portal login link 44 and a picture 46 of the vehicle as pulled from the VIN to determine make, model, year, color.

The chronicle 40 may also include one or more driving tips 48 that are generated based upon the information collected by the server 30. The driving behavior of the driver/vehicle will be deduced from driving parameters such as speed, acceleration, lane changes, braking, etc. This is used to automatically create context relevant driving and safety improvement tips. These tips are communicated to the vehicle operator/owner in the form of a set of tailored and easy to understand advice and instructions. For example, the tips could include, “properly inflate your tires to reduce fuel consumption,” “avoid frequent braking to reduce fuel consumption,” “excessive speed increases the likelihood of an accident and increased fuel consumption,” etc.

The chronicle 40 may include links 50 for forwarding, printing or saving the chronicle 40.

The chronicle 40 may include graphs relating to driver behavior, such as a speed graph 52 indicating (for example) ideal speed range (here 38 to 60) relative to the driver's average speed (here 58) and maximum speed (here 73). A driving style graph 54 rates the driver's aggressiveness (here 34) relative to an average of other drivers or this driver's previous average (here 53).

A vehicle health area 56 may include indications of needed maintenance, fuel level, oil level and condition, tire pressures, engine health, etc.

Environmental data area 58 may indicate this driver's (or this vehicle's) carbon footprint, CO2 generation, or other emissions data.

A promotion area 60 may include localized (i.e. geographically based upon vehicle or user location) and personalized (i.e. based upon vehicle diagnostics, for example) promotions that are relevant to this driver (for example an oil change coupon).

The promotion area 60 may also be a coupon that is based on the frequent route of the vehicle. A coupon will be created in the chronicle 40 to promote products or services that are personalized based on the route, gender of the driver, the car type and typical driving time. For instance, a fuel discount coupon may be included to a gas station that happens to be in the regular route of the vehicle. Similarly, a coupon to a restaurant that happens to be on the regular driving route of the vehicle may be provided. The vehicle operator can redeem the coupon at the restaurant.

The chronicle 40 format is a convenient way to periodically provide the user with a wide variety of useful information in a convenient, useful and interesting format. The user can keep the chronicles 40 for historical purposes, forward them to others, print them out for discussion (e.g. a parent discussing a chronicle 40 that is based upon the teen's driving).

The chronicle 40 format can be delivered in one of several predefined system layouts with selected content. The user can either select from one of the existing layouts, or can further personalize the chronicle to include content blocks that are most relevant to the individual user. Individual personalized layouts and content can be shared for the benefit of a larger community, or for review and inclusion as a system layout.

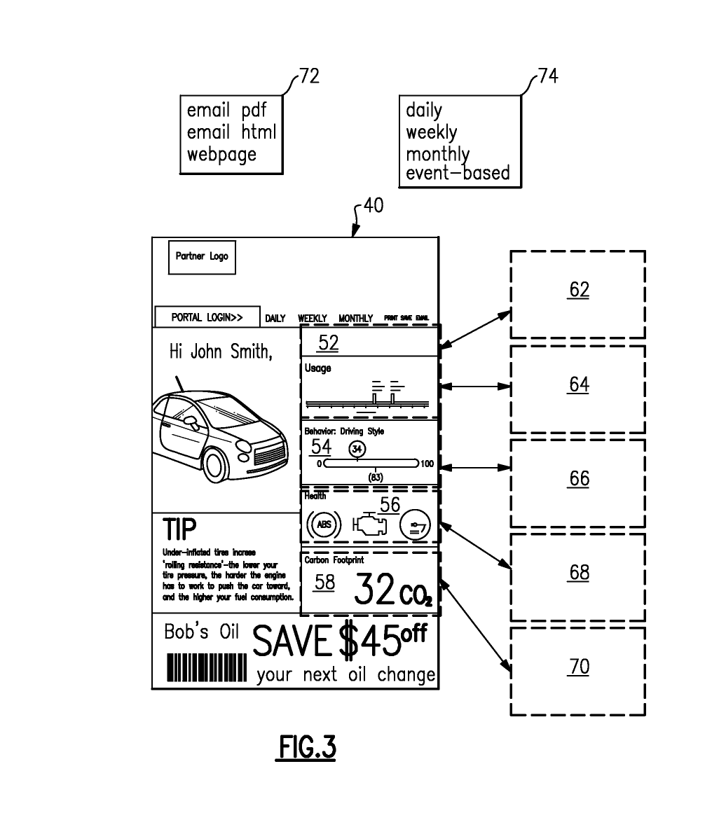

FIG. 3 shows one possible interface permitting the user to customize the chronicle 40. In the example shown, the user is customizing the chronicle 40 on a website or in an application on a cell phone or tablet. As shown, there is an area on the chronicle 40 in which the user can place a number of functional “blocks” or modules. The user can choose which blocks to include in the chronicle 40 by dragging them from an available block area on the right (blocks 6270) and dropping them in the customizable area in the chronicle 40 in the user's desired order. In FIG. 3, for example, the user has placed the speed graph 52, the driving style graph 54, the vehicle health 56 and the environmental data 58 blocks on his customized chronicle 40. This information is saved on the server 30 and associated with the user's profile 32. When he receives his chronicle 40, it will include those blocks and the information associated with those blocks as shown in FIG. 3. Other potential blocks could include maps showing frequent destinations, frequent routes or route suggestions, or other content mentioned above. The user interface may also include options for delivery of the chronicle 40. For example, a pull-down format menu 72 permits the user to choose from among several delivery formats (email pdf, email html, webpage, etc.). A pull-down frequency menu 74 permits the user to choose the frequency of delivery of the reports, such as daily, weekly, monthly or based upon certain events occurring. For event-triggered reports, another interface (not shown) would permit the user to define the triggering events, e.g. geographic triggers, speed triggers, driving behavior triggers, vehicle maintenance triggers, etc.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A vehicle monitoring and reporting system comprising:
a server receiving information from a vehicle and sending a report to a user based upon the information; and
a user interface permitting the user to customize the report based upon the information from the vehicle.

2. The vehicle monitoring and reporting system of claim 1 wherein the user can choose from a plurality of modules in the user interface to be included in the report.

3. The vehicle monitoring and reporting system of claim 1 wherein the information includes geographic locations of the vehicle and wherein the user interface permits the user to include geographic locations of the vehicle in the report.

4. The vehicle monitoring and reporting system of claim 1 wherein the information includes driving behavior and wherein the user interface permits the user to include driving behavior in the report.

5. The vehicle monitoring and reporting system of claim 1 wherein the information includes speed information and wherein the user interface permits the user to include speed information in the report.

6. The vehicle monitoring and reporting system of claim 1 wherein the user interface permits the user to choose a report frequency.

7. The vehicle monitoring and reporting system of claim 1 wherein the user interface permits the user to choose a report delivery format.

8. The vehicle monitoring and reporting system of claim 1 wherein the report includes driving tips.

9. The vehicle monitoring and reporting system of claim 1 wherein the server includes a profile for each of a plurality of users including the user, and wherein each user's customizations are stored in each user's respective profile.

10. A method for monitoring and reporting vehicle information including the steps of:
a) receiving information from a vehicle;
b) receiving customization preferences from a user; and
c) generating a report based upon the information and based upon the customization preferences.

11. The method of claim 10 further including the step of providing a plurality of modules in a user interface from which the user can choose to be included in the report.

12. The method of claim 10 wherein the information includes geographic locations of the vehicle and further including the step of providing in the user interface an option for the user to include geographic locations of the vehicle in the report.

13. The method of claim 10 wherein the information includes driving behavior and further including the step of providing in the user interface an option for the user to include driving behavior in the report.

14. The method of claim 10 wherein the information includes speed information and further including the step of providing in the user interface an option for the user to include speed information in the report.

15. The method of claim 10 further including the step of providing in the user interface an option for the user to choose a report frequency.

16. The method of claim 10 further including the step of providing in the user interface an option for the user to choose a report delivery format.

17. The method of claim 10 further including the step of generating driving tips and wherein the report includes driving tips.

18. The method of claim 10 further including the step of storing the user's customizations in a profile among a plurality of profiles.

19. The method of claim 10 wherein the information includes geographic locations of the vehicle and further including the step of generating a report that includes a coupon based upon the geographic locations of the vehicle.

20. The method of claim 10 wherein said step b) further includes the step of receiving an event-based trigger for delivering the report to the user, said method further including the step of detecting the event and delivering the report to the user based upon the detection of the event.
